(19) United States
(12) Patent Application Publication
(10) Pub. No.: US 2008/0201282 A1
(43) Pub. Date: Aug. 21, 2008

(54) System and Method for Locating Points of Interest in an Object Image Implementing a Neural Network

(75) Inventors: Christophe Garcia, Rennes (FR); Stefan Duffner, Rennes (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Rennes (FR)

(21) Appl. No.: 11/910,159

(22) PCT Filed: Mar. 28, 2006
(86) PCT No.: PCT/EP06/61110

§ 371 Date: Apr. 21, 2008

(30) Foreign Application Priority Data
Mar. 31, 2005 (FR) 0503177

(51) Int. Cl. G06T 1/40; G06F 15/18

(52) U.S. Cl. 706/20; 706/25

(57) ABSTRACT

A system is provided for locating at least two points of interest in an object image. One such system uses an artificial neural network and has a layered architecture having: an input layer, which receives the object image; at least one intermediate layer, known as the first intermediate layer, consisting of a plurality of neurons that can be used to generate at least two saliency maps, which are each associated with a different pre-defined point of interest in the object image; and at least one output layer, which contains the aforementioned saliency maps. The maps include a plurality of neurons, which are each connected to all of the neurons in the first intermediate layer. The points of interest are located in the object image by the position of a unique global maximum on each of the saliency maps.

### CROSS-REFERENCE TO RELATED APPLICATION

This Application is a Section 371 National Stage Application of International Application No. PCT/EP2006/061110, filed Mar. 28, 2006 and published as WO 2006/103241 A2 on Oct. 5, 2006, not in English.

### FIELD OF THE DISCLOSURE

The field of the disclosure is that of the digital processing of still or moving images. More specifically, the disclosure relates to a technique for locating one or more points of interest in an object represented in a digital image.

The disclosure can be applied especially but not exclusively in the field of the detection of physical characteristics in the faces in a digital or digitized image, for example the pupil, the corner of the eyes, the tip of the nose, mouth, eyebrows etc. Indeed, the automatic detection of points of interest in images of faces is a major issue in facial analysis.

### BACKGROUND

In this field, there are several known techniques most of which consists in independently seeking and detecting each particular facial feature by means of dedicated, specialized filters.

Most of the detectors used rely on an analysis of the chrominance of the face: the pixels of the face are labeled as belonging to the skin or to facial elements according to their color.

Other detectors use contrast variations. To this end, a contour detection is applied, relying on the analysis of the light gradient. It is then attempted to identify the facial elements from the different contours detected.

Other approaches implement a search by correlation, using statistical models of each element. These models are generally built from Principal Component Analysis (PCA) using imagettes of each of the elements to be sought (or eigenfeatures).

Certain prior-art techniques implement a second phase in which a geometrical face model is applied to all the candidate positions determined in the first phase of independent detection of each element. The elements detected in the initial phase form constellations of candidate positions and the geometrical model which can be morphable is used to select the best constellation.

One recent method can be used to go beyond the classic two-step scheme (involving independent searches for facial elements followed by the application of geometrical rules). This method relies on the use of active appearance models (AAMs) and is described especially by D. Cristinacce and T. Cootes, in “A comparison of shape constrained facial feature detectors” (Proceedings of the 6^{th} International Conference on Automatic Face and Gesture Recognition 2004, Seoul, Korea, pp 375-380, 2004). It consists in predicting the position of the facial elements by attempting to make an active face model correspond with the face in the image, by adapting the parameters of a linear model combining shape and texture. This face model is learnt from faces on which the points of interest are annotated by means of a principal components analysis (PCA) on the vectors encoding the position of the points of interest and the light textures of the associated faces.

The main drawback of these various prior-art techniques is their low robustness in the face of the noise that affects face images, and especially object images.

Indeed, the detectors designed specifically to detect different facial elements do not withstand extreme conditions of illumination of images, such as over-lighting or under-lighting, side lighting, lighting from below. They also show little robustness with respect to variations in quality of the image, especially in the case of low-resolution images obtained from video streams (acquired for example by means of a webcam) or having undergone prior compression.

Methods relying on the chrominance analysis (which apply a filtering of flesh color) are also sensitive to lighting conditions. Furthermore, they cannot be applied to images in grey levels.

Another drawback of these prior art techniques, relying on the independent detection of different points of interest, is that they are totally inefficient when these points of interest are concealed, which is the case for example for the eyes when dark glasses are being worn, the mouth when there is a beard or when it is concealed by the hand, and more generally when there is high local deterioration of the image.

Failure to detect several elements or even only one element is generally not corrected by the subsequent use of a geometrical face model. This model is used only when a choice has to be made among several candidate positions, which should imperatively have been detected in the previous stage.

These different drawbacks are partially compensated for in the methods relying on active faces, which enable a general search for elements through the joint use of shape and texture information. However, these methods have another drawback which is that they rely on a slow and unstable process of optimisation that depends on hundreds of parameters which have to be determined iteratively during the search, and this is a particularly long and painstaking process.

Furthermore, since the statistical models used are linear, created by PCA, they show low robustness with respect to the overall variations in the image, especially lighting variations. They have low robustness with respect to partial concealments of the face.

### SUMMARY

An embodiment of the present invention is directed to a system for locating at least two points of interest in an object image, applying an artificial neural network and presenting a layered architecture comprising:

an input layer receiving said object image;

at least one intermediate layer, called a first intermediate layer, comprising a plurality of neurons enabling the generation of at least two saliency maps each associated with a predefined distinct point of interest of said object image;

at least one output layer comprising said saliency maps, themselves comprising a plurality of neurons, each connected to all the neurons of said first intermediate layer

Said points of interest are located in the object image by the position of a unique overall maximum value on each of said saliency maps.

Thus, an embodiment of the invention is based on a wholly normal and inventive approach to the detection of several points of interest in an image representing an object since it proposes the use of a neural layered architecture enabling the generation of several saliency maps at the output, enabling direct detection of the points of interest to be located, by simple search for the maximum value.

An embodiment of the invention therefore proposes a comprehensive search, in the entire object image, of different points of interest by the neural network, making it possible to take account especially of the relative positions of these points, and also makes it possible to overcome problems related to their total or partial concealment.

The output layer comprises at least two saliency maps each associated with a predefined distinct point of interest. It is thus possible to make a simultaneous search for several points of interest in a same image by dedicating each saliency map to a particular point of interest: this point is then located through a search for a unique maximum value on each map. This is easier to implement than a simultaneous search for several local maximum values in a total saliency map, associated with all the points of interest.

Furthermore, it is no longer necessary to design and develop filters dedicated to the detection of the different points of interest. These filters are located automatically by the neural network after completion of a preliminary learning phase.

A neural architecture of this kind furthermore proves to be more robust than prior-art techniques with respect to possible problems of the lighting of object images.

It must be specified that in this case the term “predefined point of interest” is understood to mean a remarkable element of an object, for example in the case of a face image, it would be an eye, nose, mouth etc.

An embodiment of the invention therefore consists in making a search not for any contour in an image but for a predefined identified element.

According to an advantageous characteristic, said object image is a face image. The points of interest sought are then permanent physical features, such as the eyes, the nose, the nose, the eyebrows etc.

Advantageously, a locating system of this kind also comprises at least one second intermediate convolution layer comprising a plurality of neurons. Such a layer can be specialized in the detection of low-level elements such as contrast lines in the object image.

Preferably, a locating system of this kind also comprises at least one third sub-sampling intermediate layer comprising a plurality of neurons. Thus, the dimension of the image on which work is done is reduced.

In a preferred embodiment of the invention, such a locating system comprises, between said input layer and said first intermediate layer:
a second intermediate convolution layer comprising a plurality of neurons and enabling the detection of at least one elementary line type shape in said object image, said second intermediate layer delivering a convoluted object image;
a third intermediate sub-sampling layer comprising a plurality of neurons and enabling a reduction of the size of said convoluted object image, said third intermediate layer delivering a reduced convoluted object image;
a fourth intermediate convolution layer comprising a plurality of neurons and enabling the detection of at least one corner type complex shape in said reduced convoluted object image.

An embodiment of the invention also relates to a learning method for a neural network of a system for locating at least two points of interest in an object image as described here above. Each of said neurons has at least one input weighted by a synaptic weight, and a bias. A learning method of this type comprises the following steps:
building a learning base comprising a plurality of object images annotated as a function of said points of interest to be located;
initializing said synaptic weights and/or said biases
for each of said annotated images of said learning base:
   preparing said at least two desired saliency maps at the output from each of said at least two annotated, predefined points of interest on said image;
   presenting said image at the input of said system for locating and determining said at least two saliency maps delivered at the output;
minimizing a difference between said desired saliency maps delivered at the output on the set of said annotated images of said learning base so as to determine said synaptic weights and/or said optimal biases.

Thus, depending on examples manually annotated by a user, the neural network learns to recognize certain points of interest in the object images. It will then be capable of locating them in any image given at the input of the network.

Advantageously, said minimizing is a minimizing of a mean square error between said desired saliency maps delivered at the output and applies an iterative gradient backpropagation algorithm. This algorithm is described in detail in appendix 2 of the present document, and enables fast convergence with the optimal values of the different biases and synaptic weights of the network.

An embodiment of the invention also relates to a method for locating at least two points of interest in an object image, comprising the steps of:
presenting said object image at the input of a layered architecture implementing an artificial neural network;
successively activating at least one intermediate layer, called a first intermediate layer, comprising a plurality of neurons and enabling the generation of at least two saliency maps each associated with a predefined, distinct point of interest of said object image, and of at least one output layer comprising said saliency maps, said saliency maps comprising a plurality of neurons each connected to all the neurons of said first intermediate layer;
locating said points of interest in said object image by searching, in said saliency maps, for a position of a unique overall maximum on each of said maps.

According to an advantageous characteristic of an embodiment of the invention, a locating method of this kind comprises preliminary steps of:
detection, in any image whatsoever, of a zone encompassing said object and constituting said object image;
resizing of said object image.

This detection can be done from a classic detector, well known to those skilled in the art, for example a face detector which can be used to determine a box encompassing a face in a complex image. The resizing can be done automatically by the detector, or independently by dedicated means: it enables images, all of the same size, to be given at input of the neural network.

An embodiment of the invention also relates to a computer program comprising program code instructions for the execution of the learning method for a neural network described here above when said program is executed by a processor, as well as a computer program comprising program code instructions for the execution of the method for locating at least two points of interest in an object image described here above when said program is executed by a processor.

Such programs can be downloaded from a communications network (for example the Internet worldwide network) and/or stored in a computer-readable data carrier.

Other features and advantages shall appear more clearly from the following description of the preferred embodiment given by way of an illustrative and non-restrictive example, and from the appended drawings.

### BRIEF DESCRIPTION OF THE DRAWINGS

FIG. 1 is a block diagram of the neural architecture of the system for locating points of interest in an object image of an embodiment of the invention;

FIG. 2 provides a more precise illustration of a convolution map, followed by a sub-sampling map in the neuronal architecture of FIG. 1;

FIGS. 3a and 3b present a few examples of facial images of the learning base;

FIG. 4 describes the major steps of the method for locating facial elements in a facial image according to an embodiment of the invention;

FIG. 5 is a simplified block diagram of the locating system of an embodiment of the invention;

FIG. 6 is an example of an artificial neural network of the multilayer perceptron type;

FIG. 7 provides a more precise illustration of the structure of an artificial neuron; and

FIG. 8 presents the characteristics of the hyperbolic tangential function used as a transfer function for the sigmoid neurons.

### DETAILED DESCRIPTION OF ILLUSTRATIVE EMBODIMENTS

### 1. Description of an Illustrative Embodiment of the Invention

The general principle of an embodiment of the invention relies on the use of a neural architecture to enable the automatic detection of several points of interest in object images (more specifically semi-rigid objects), and especially in images of faces (detection of permanent features such as eyes, nose or mouth). More specifically, the principle of an embodiment of the invention consists in constructing a neural network by which it is possible to learn to convert, in one operation, an object image into several saliency maps for which the positions of the maximum values correspond to the positions of points of interest selected by the user in the object image given at the input.

This neural architecture consists of several heterogeneous layers that enable the automatic development of robust low-level detectors and at the same time provide for the learning of the rules used to govern plausible relative arrangements of the elements detected and enable any available piece of information to be taken into account to locate concealed elements, if any.

All the connection weights of the neurons are set during the learning phase, from a set of pre-segmented object images and from the positions of the points of interest in these images.

The neural architecture thereafter acts like a cascade of filters enabling the conversion of an image zone containing an object, preliminarily detected in a bigger-sized image or in a video sequence, into a set of digital maps having the size of the input image, whose elements range between −1 and 1. Each map corresponds to a particular point of interest whose position is identified by a simple search for the position of the element whose value is the maximum value.

It will be attempted throughout the remainder of this document to describe more particularly an exemplary embodiment of the invention in the context of the detection of several facial elements on one face image. However, an embodiment of the invention can be applied of course also to the detection of any points of interest in an image representing an object, such as for example the detection of elements of the bodywork of an automobile or the architectural characteristics of a set of buildings.

In this context of the detection of physical characteristics in face images, the method of an embodiment of the invention enables robust detection of the facial elements in faces, in various poses (orientations, semi-frontal views) with varied facial expressions, possibly containing concealing elements and appearing in images that have high variability in terms of resolution, contrast and illumination.

### 1.1 Neural Architecture

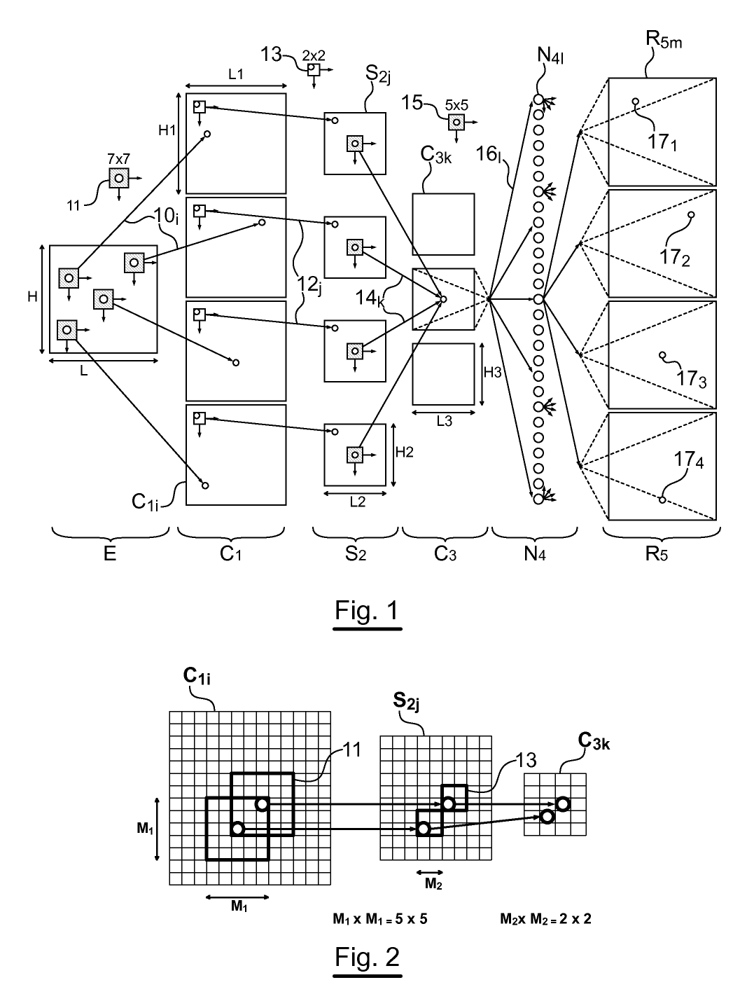

Referring to FIG. 1, we present the architecture of the artificial neural network of the system of an embodiment of the invention for locating points of interest. The working principle of such artificial neurons, as well as their structure, is recalled in appendix 1, which forms an integral part of the present description. A neural network of this kind is for example a multilayer perceptron type network also described in appendix 1.

A neural network such as this consists of six interconnected heterogeneous layers referenced E, C₁, S₂, C₃, N₄ and R₅, which contain a series of maps coming from a succession of convolution and sub-sampling operations. By their successive and combined actions, these different layers extract primitives in the image presented at the input leading to the production of output maps R₅ₘ, from which the positions of the point of interest can be easily determined.

More specifically, the proposed architecture comprises:
an input layer E: this is a retina which is an image matrix sized H×L where H is the number of rows and L is the number of columns. The input layer E receives the elements of a same sized image zone H×L. For each pixel P_{i,j} of the image presented at the input of the neural network in grey levels (P_{i,j} varying from zero 0 to 255), the corresponding element of the matrix E is Eᵢⱼ=(Pᵢⱼ−128)/128, with a value ranging between −1 and 1. Values of H=56 and L=46 are chosen. H×L is therefore also the size of the face images of the learning base used for the parametrizing of the neural network and of the face images in which it is desired to detect one or more facial elements. This size may be the one obtained directly at the output of the face detector which performs the extraction, from the face images, of larger-sized images or video sequences. It may also be the size at which the face images are resized after extraction by the face detector. Preferably, a resizing of this kind keeps the natural proportions of the faces.
A first convolution layer C₁, constituted by NC₁ maps referenced C₁ᵢ. Each map C₁ᵢ is connected 10ᵢ to the input map E, and comprises a plurality of linear neurons (as presented in appendix 1). Each of these neurons is connected by synapses to a set of M₁×M₁ neighboring elements in the map E (receptive fields) as described in greater detail in FIG. 2. Each of these neurons furthermore receives a bias. These M₁×M₁ synapses, plus the bias, are shared by the set of the neurons of C₁ᵢ. Each map C₁ᵢ therefore corresponds to the result of a convolution by a M₁×M₁ core 11 increased by a bias, in the input map E. This convolution specializes as the detector of certain low-level shapes in the input map such as for example oriented contrast lines of the image. Each map C₁ᵢ is therefore sized H₁×L₁ where H₁=(H−M₁+1) and L₁=(L−M₁+1), to prevent the edge effects of the convolution. For example the layer C₁ contains NC₁=4 maps sized 50×41 with convolution cores sized NN₁×NN₁=7×7;
A sub-sampling layer S₂ constituted by NS2 maps S₂ⱼ. Each map S₂ⱼ is connected 12ⱼ to a corresponding map C₁ᵢ. Each neuron of a map S₂ⱼ receives the average of M₂×M₂ neighboring elements 13 in the map C₁ᵢ (receptive fields) as illustrated in greater detail in FIG. 2. Each neuron multiplies this average by a synaptic weight and adds a bias thereto. The synaptic weight and the bias, whose optimum values are determined in a learning phase, are shared by the set of neurons of each map S₂ⱼ. The output of each neuron is obtained after passage into a sigmoid function. Each map S₂ⱼ is sized H₂×L₂ where H₂=H₁/M₂ and L₂=L₁/M₂. for example, the layer S₂ contains NS₂=4 maps sized 25×20 with a sub-sampling 1 for NN₂×NN₂=2×2;
A convolution layer C₃, consisting of NC₃ maps C₃ₖ. Each map C₃ₖ is connected 14ₖ to each of the maps S₂ⱼ of the sub-sampling layer S₂. The neurons of a map C₃ₖ are linear and each of these neurons is connected by synapses to a set of M₃×M₃ neighboring elements 15 in each of the maps S₂ⱼ.

It furthermore receives a bias. The M₃×M₃ synapses per map plus the bias I are shared by the set of neurons of the maps C₃ₖ. The maps C₃ₖ correspond to the result of the sum of NC₃ convolutions by cores M₃×M₃ 15, increased by a bias. These convolutions enable the extraction of the highest-level characteristics, such as corners, in combining extractions on the contribution maps C₁ᵢ at input. Each map C₃ₖ is sized H₃×L₃ where H₃=(H₂−M₃+1) and L₃=(L₂−M₃+1). For example, the layer C₃ contains NC₃=4 maps sized 21×16 with a convolution core sized NN₃×NN₃=5×5;
a layer N₄ of NN₄ sigmoid neurons N₄₁. Each neuron of the layer N₄ is connected 16, to all the neurons of the layer C₃, and receives a bias. These neurons N₄ₗ are used for learning to generate output maps R₅ₘ in maximizing the responses on the positions of the points of interest in each of these maps, while taking account of the totality of the maps C₃, so that it is possible to detect a particular point of interest in taking account of the detection of the others. The value chosen is for example NN₄=100 neurons, and the hyperbolic tangential function (referenced th or tanh) is chosen for the transfer function of the sigmoid neurons.
a layer R₅ of maps, constituted by NR₅ maps R₅ₘ, one for each point of interest chosen by the user (right eye, left eye, nose, mouth etc.). Each map R₅ₘ is connected to all the neurons of the layer N₄. The neurons of a map R₅ₘ are sigmoid and each is connected to all the neurons of the layer N₄. Each map R₅ₘ is sized H×L, which is the size of the input layer E. The value chosen for example is NR₅=4 maps sized 56×46. after activation of the neural network, the position of the neuron 17₁, 17₂, 17₃, 17₄ with a maximum output in each map R₅ₘ corresponds to the position of the corresponding facial element in the image presented at input of the network. It will be noted, that in one variant of an embodiment of the invention, the layer R₅ has only one saliency map in which all the points of interest to be located in the image are presented.

FIG. 2 illustrates a map C₁ᵢ of 5×5 convolution 11 followed by a map S₂ⱼ of 2×2 sub-sampling 13. It can be noted that the convolution performed does not take account of the pixels situated on the edges of the map C₁ᵢ, in order to prevent edge effects.

In order to be able to detect the points of interest in the face images, it is necessary to parametrize the neural network of FIG. 1 during a learning phase described here below.

1.2 Learning from an Image Base

After construction of the layered neural architecture described here above, a learning base of annotated images is therefore built so as to adjust the weight of the synapses of all the neurons of the architecture by learning.

To do this, the procedure described here below is performed:

First of all, a set T of images of faces is extracted manually from a large-sized body of images. Each face image is resized to the size H×L of the input layer E of the neural architecture, preferably in keeping the natural proportions of the faces. It is seen to that images of faces of varied appearances are extracted.

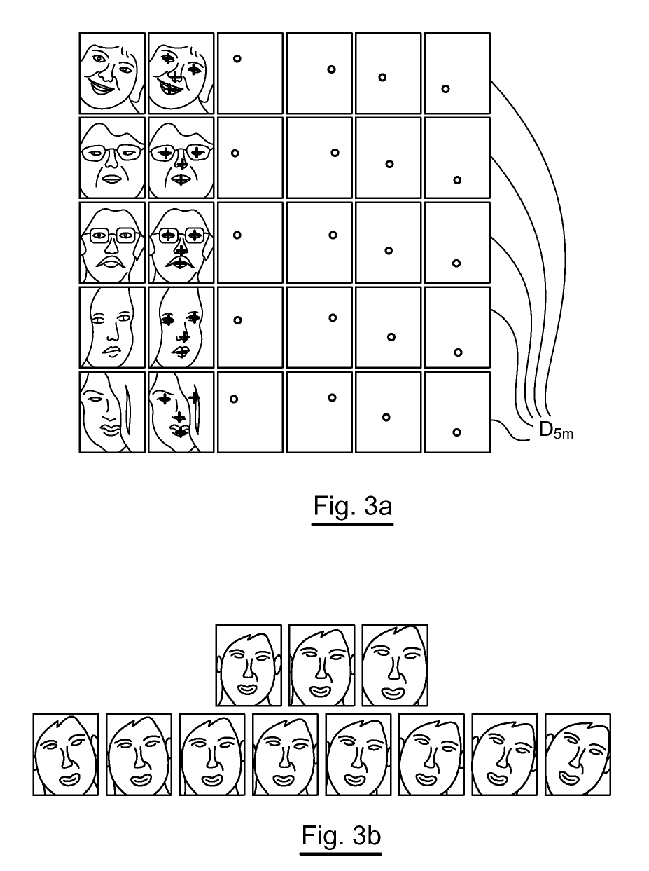

In a particular embodiment focusing on the detection of four points of interest in the face (mainly the right eye, left eye, nose and mouth), the positions of the eyes, nose and centre of the mouth are identified manually as illustrated in FIG. 3a: thus, there is obtained a set of images annotated as a function of the points of interest which the neural network will have to learn to locate. These points of interest to be located in the images may be freely chosen by the user.

In order to automatically generate examples that are more varied, a set of transformation is applied to these images as well as to the annotated positions such as column wise and row-wise translations (for example up to six pixels to the left, to the right, upwards and downwards), rotations relative to the centre of the image by angles varying from −25° to +25°, backward and forward zooms from 0.8 to 1.2 times the size of the face. From a given image, a plurality of converted images is thus obtained, as illustrated in FIG. 3b. The variations applied to the images of faces can be used to take account, in the learning phase, not only of the possible appearances of the faces but also of possible centering errors during the automatic detection of the faces.

The set T is called a learning set.

For example, it is possible to use a learning base of about 2,500 images of faces annotated manually as a function of the position of the centre of the left eye, right eye, nose and mouth. After application of geometrical modifications to these annotated images (translations, rotations, zooms, etc), about 32,000 examples of annotated faces are obtained, showing high variability.

Then, the set of synaptic weights and the biases of the neural architecture are automatically learned. To this end, first of all the biases and synaptic weights of the set of neurons are randomly initialized at small values. The N_{T} images I of the set T are then presented in any unspecified order in an input layer E of the neural network. For each image I presented, the output maps D₅ₘ that the neural network must deliver in the layer R₅ if its operation is optimum are prepared: these maps D₅ₘ are called desired maps.

On each of these maps D₅ₘ, the value for the set of points is fixed at −1, except for the point whose position corresponds to that of the facial element which the map D₅ₘ must render possible to locate and whose desired value is 1. These maps D₅ₘ are illustrated in FIG. 3a, where each point corresponds to the point having a value +1, whose position corresponds to that of a facial element to be located (right eye, left eye, nose or centre of the mouth).

Once the maps D₅ₘ have been prepared, the input layer E and the layers C₁, S₂, C₃, N₄, and R₅ of the neural network are activated one after the other.

In a layer R₅, we then obtain the response of the neuron network to the image I. The aim is to obtain maps R₅ₘ identical to the desired maps D₅ₘ. We therefore define an objective function to be minimized in order to attain this goal:

$$O = \frac{1}{{N}_{T} \times {NR}_{5} \times H \times L} {\sum }_{k = 1}^{{N}_{T}} {\sum }_{m = 1}^{{NR}_{5}} {\sum }_{( i , j ) ∈ H \times L} {( {R}_{5 m}^{( i , j )} - {D}_{5 m}^{( i , j )} )}^{2}$$

where (i,j) corresponds to the element at the row i and the column j of each map R₅ₘ. What is done therefore is to minimize the mean square error between the produced maps R₅ₘ and desired maps D₅ₘ on the set of annotated maps of the learning set T.

To minimize the objective function O, the iterative gradient backpropagation algorithm is used. The principle of this algorithm is recalled in appendix 2 which is an integral part of the present description. A gradient backpropagation algorithm of this kind can thus be used to determine all the synaptic weights and optimum biases of the set of neurons of the network.

For example, the following parameters can be used in the gradient backpropagation algorithm:
a 0.005 learning step for the neurons of the layers C₁, S₂, C₃;
a 0.001 learning step for the neurons of the layer N₄;
a 0.0005 learning step for the neurons of the layer R₅;
a momentum of 0.2 for the neurons of the architecture.

The gradient backpropagation algorithm then converges on a stable solution after 25 iterations, if one iteration of the algorithm is deemed to correspond to the presentation of all the images of the learning set T.

Once the optimum values of the biases and synoptic weights have been determined, the neural network of FIG. 1 is ready to process any unspecified digital face image in order to extract therefrom the annotated points of interest in the images of the learning set T.

### 1.3 Search for Points of Interest in an Image

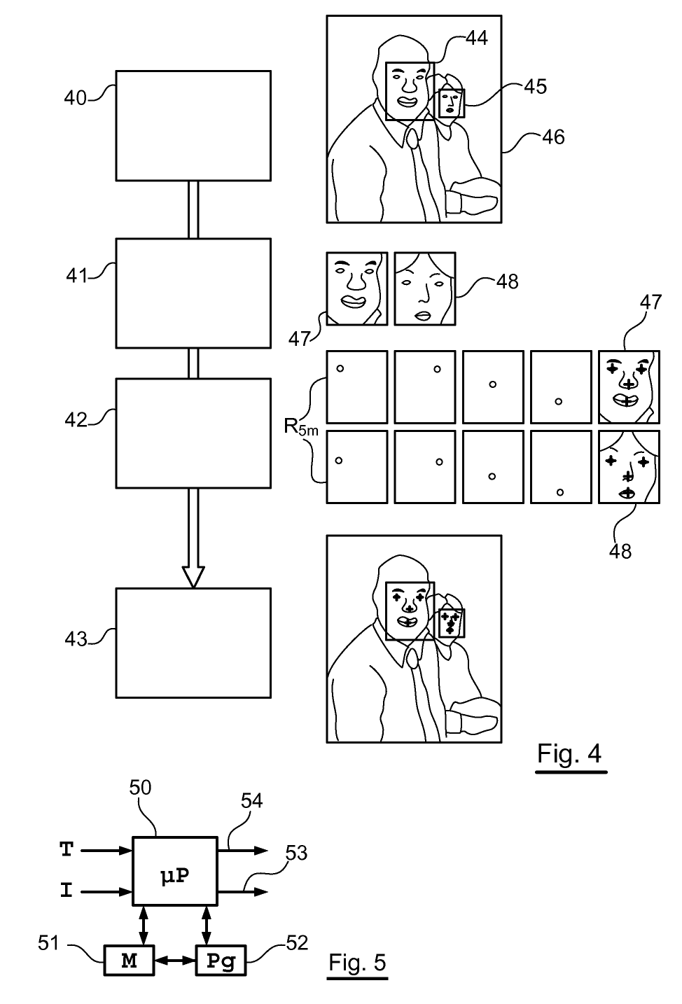

It is henceforth possible to use the neural network of FIG. 1, set in the learning phase, to search for facial elements in a face image. The method used to carry out a location of this kind is presented in FIG. 4.

We detect 40 the faces 44 and 45 present in the image 46 by using a face detector. This face detector locates the box encompassing the interior of each face 44, 45. The zones of images contained in each encompassing box are extracted 41 and constitute the images of faces 47, 48 in which the search for the facial elements must be made.

Each extracted face image I 47, 48 is resized 41 to the size H×L and placed at the input E of the neural architecture of FIG. 1. The input layer E, the intermediate layers C₁, S₂, C₃, N₄, and the output layer R₅ are activated one after the other so as to bring about a filtering 42 of the image I 47, I 48 by the neural architecture.

In a layer R₅, a response from the neural network to the image I 47, 48, is obtained in the form of four saliency maps R₅ₘ for each of the images I 47, 48.

Then the points of interest are located 43 in the face images I 47, 48 by a search for maximum values in each saliency map R₅ₘ. More specifically, in each of the maps R₅ₘ, a search is made for the position

$$( {i}_{{m}_{max}} , {j}_{{m}_{max}} )$$

such that

$$( {i}_{{m}_{max}} , {j}_{{m}_{max}} ) = arg {max}_{( i , j ) ∈ H \times L} {R}_{5 m}^{( i , j )}$$

for mεNR₅. This position corresponds to the sought position of the point of interest (for example the right eye) that corresponds to this map.

In a preferred embodiment of the invention, the faces are detected 40 in the images 46 by the face detector CFF presented by C. Garcia and M. Delakis, in “Convolutional Face Finder: a Neural Architecture for Fast and Robust Face Detection,” IEEE Transactions on Pattern Analysis and Machine Intelligence, 26(11): 1408-1422, November 2004.

A face finder of this kind can indeed be used for the robust detection of faces of minimum size 20×20, sloped up to ±25 degrees and rotated by up to ±60 degrees in complex background scenes, and under variable forms of lighting. The CFF finder determines 40 the box encompassing the faces detected 47, 48 and the interior of the box is extracted, then resized 41 to the size H=56 and L=46. Each image is then presented at the input of the neural network of FIG. 1.

The locating method of FIG. 1 has particularly high robustness with respect to the high variability of the faces present in the images.

Referring to FIG. 5, we now present a simplified block diagram of a system or device for locating points of interest in an object image. Such a system comprises a memory M 51 and a processing unit 50 equipped with a processor μP, which is driven by the computer program Pg 52.

In a first learning phase, the processing unit 50 receives a set T of learning face images at the input, annotated according to points of interest that the system should be able to locate in an image. From this set, the microprocessor μP, according to the instructions of the program Pg 52, applies a gradient backpropagation algorithm to optimize the values of the biases and synaptic weights of the neural network.

These optimum values 54 are then stored in the memory M 51.

In a second phase of searching for points of interest, the optimum values of the biases and synaptic weights are loaded from the memory M 51. The processing unit 50 receives an object image I at the input. From this image, the microprocessor μP, working according to the instructions of the program Pg 52, performs a filtering by the neural network and a search for maximum values in the saliency maps obtained at the output. At the output of the processing unit 50, coordinates 53 are obtained for each of the points of interest sought in the image I.

On the basis of the positions of the points of interest detected through an embodiment of the present invention, many applications become possible, for example the encoding of faces by models, synthetic animation of images of faces fixed by local morphing, methods of shape recognition or emotion recognition based on local analysis of characteristic features (eyes, nose, mouth) and more generally man-machine interactions using artificial vision (following the direction in which the user is looking, lip-reading etc).

An aspect of the disclosure provides a technique for locating several points of interest in an image representing an object that does not necessitate any lengthy and painstaking development of filters specific to each point of interest which needs to be capable of being located, and to each type of object.

An aspect of the disclosure proposes a locating technique of this kind that is particularly robust with respect to all the noises that can affect the image, such as illumination conditions, chromatic variations, partial concealment etc.

An aspect of the disclosure provides a technique of this kind that takes account of concealment that partially affects the images, and enables the inference of the position of the concealed points.

An aspect of the disclosure provides a technique of this kind that is simple to apply and costs little to implement.

An aspect of the disclosure provides a technique of this kind that is particularly well suited to the detection of facial elements in images of faces.

Although the present disclosure have been described with reference to one or more examples, workers skilled in the art will recognize that changes may be made in form and detail without departing from the spirit and scope of the disclosure and/or the appended claims.

### APPENDIX 1

### Artificial Neurons and Multilayer Perceptron Neural Networks

1. General Points

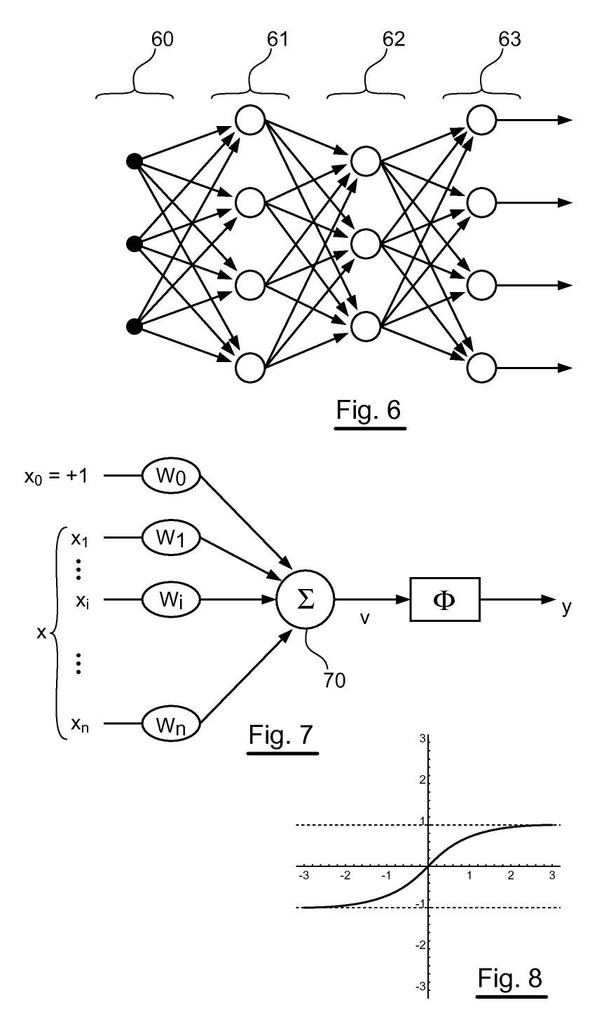

The multilayer perceptron is an oriented network of artificial neurons organized in layers, in which the information travels in only one direction, from the input layer to the output layer. FIG. 6 shows an example of a network containing an input layer 60, two concealed layers 61 and 62, and an output layer 63. The input layer C always represents a virtual layer associated with the inputs of the system. It contains no neurons. The next layers 61 to 63 are neural layers. As a rule, a multilayer perceptron may have any number of layers and also any number of neurons (or inputs) per layer

In the example shown in FIG. 6, the neural network has 3 inputs, 4 neurons on the first concealed layer 61, 3 neurons on the second layer 62 and 4 neurons on the output layer 63. The outputs of the neurons of the last layer 63 correspond to the outputs of the system.

An artificial neurons is a computation unit that receives an input signal (X, vector of real values), through synaptic conditions which bear weights (real values wⱼ), and deliver an output at the real value y. FIG. 7 shows the structure of an artificial neuron of this kind, the working of which is described in paragraph §2 here below.

The neurons of the network of FIG. 6 are connected to one another, from layer to layer, by weighted synaptic connections. It is the weights of these connections that govern the working of the network and “program” an application from the input space to the output space through a non-linear conversion. The creation of a multilayer perceptron to resolve a problem therefore requires the inference of the best possible application, as defined by a set of learning data constituted by pairs of desired input and output vectors.

2. The Artificial Neuron

As indicated here above, an artificial neuron is a computation unit which receives a vector X, a vector of n real values [x₁, . . . , xᵢ, . . . , xₙ], as well as a fixed value equal to x₀=+1.

Each of the inputs xᵢ, excites a synapse weighted by wᵢ. A summing function 70 computes a potential V which, after passing in an activation function φ, gives an output with a real value y.

The potential V is expressed as follows:

$$V = {\sum }_{i = 0}^{n} {w}_{i} {x}_{i}$$

The quantity w₀x₀ is called a bias and corresponds to a threshold value for the neuron.
The output y can be expressed in the form:

$$\begin{matrix}y = Φ ( V ) \\ = Φ ( {\sum }_{i = 0}^{n} {w}_{i} {x}_{i} )\end{matrix}$$

The function φ can take different forms according to the applications aimed at.
In the context of the method of an embodiment of the invention for locating points of interest, two types of activation functions are used:
For the neurons with linear activation function we have: φ(x)=x. This is the case for example with the neurons of the layer C₁ and C₃ of the network of FIG. 1;
For the neurons with a sigmoid non-linear activation function, we choose for example the hyperbolic tangential function whose characteristic curve is illustrated in FIG. 8:

$$\begin{matrix}Φ ( x ) = tanh ( x ) \\ = \frac{( {e}^{x} - {e}^{- x} )}{( {e}^{x} + {e}^{- x} )}\end{matrix}$$

with real values between −1 and 1. This is the case for example with the neurons of the layers S₂, N₄ and R₅ of the network of FIG. 1.

### APPENDIX 2

### Gradient Backpropagation Algorithm

As described here above in this document, the neural network learning process consists in determining all the weights of the synaptic conditions so as to obtain a vector of desired outputs D as a function of an input vector X. To this end, a learning base is constituted, consisting of a list of K corresponding input/output pairs (Xₖ, Dₖ).

In letting Yₖ denote the output of the network obtained at an instant t for the inputs Xₖ, it is sought therefore to minimize the mean square error on the output layer:

$$E = \frac{1}{K} {\sum }_{k = 1}^{K} {E}_{k}$$

where

Eₖ=∥Dₖ−Yₖ∥² (1).

To do this, a gradient descent is done by means of an iterative algorithm:

$${E}^{( t )} = {E}^{( t - 1 )} - ρ ∇ {E}^{( t - 1 )}$$

$$where$$

$$∇ {E}^{( t - 1 )} = 〈 \frac{\partial {E}^{( t - 1 )}}{\partial {w}_{0}} , … , \frac{\partial {E}^{( t - 1 )}}{\partial {w}_{j}} , … , \frac{\partial {E}^{( t - 1 )}}{\partial {w}_{P}} 〉$$

is a gradient of the mean square error at the instant (t−1) relative to the set of the P synaptic connection weights of the network, and where ρ is the learning step.

The implementation of this gradient descent step in a neural network requires the gradient backpropagation algorithm.

Let us take a neural network, where:
c=0 is the index of the input layer;
c=1 . . . C−1 are the indices of the intermediate layers
c=C is the index of the output layer;
i=1 to n_{c} are the indices of the neurons of the layer indexed c;
S_{i,c} is the set of neurons of the layer indexed c−1 connected to the inputs of the neuron i of the layer indexed c;
w_{j,i} is the weight of the synaptic connection extending from the neuron j to the neuron i.

The gradient backpropagation algorithm works in two successive steps which are steps of forward propagation and backpropagation.
during the propagation step, the input signal Xₖ goes through the neural network and activates an output response Yₖ;
during the backpropagation, the error signal Eₖ is backpropagated in the network, enabling the synaptic weights to be modified to minimize the error Eₖ.

More specifically, such an algorithm comprises the following steps:

Fix the learning step ρ at a sufficiently small positive value (of the order of 0.001)
Fix the momentum α at a positive value between 0 and 1 (of the order of 0.2)
Randomly reset the synaptic weights of the network at small values

### Repeat

Choose an even parity example (Xₖ, Dₖ):

propagation: compute the outputs of the neurons in the order of the layers
Load the example Xₖ into the input layer: Y₀=Xₖ and assign

D=Dₖ=└d₁, . . . , dᵢ, . . . , dₙ_{_{C}}┘
For the layers c from 1 to C
   For each neuron i of the layer c (i from 1 to n_{c})
      Compute the potential:

$${V}_{i , c} = {\sum }_{j ∈ {S}_{i , c}} {w}_{j , i} {y}_{j , c - 1}$$

and the output where

Y_{c}=└y_{1,c}, . . . , y_{i,c}, . . . , yₙ_{_{c}}_{,c}┘

backpropagation: compute in the inverse order of the layers:
For the layers c from C to 1
   For each neuron i of the layer c (i from 1 to n_{c})
      Compute:

$${δ}_{i , c} = \{ \begin{matrix}( {d}_{i} - {y}_{i , C} ) {Φ}^{′} ( {V}_{i , C} ) & if c = C ( output layer ) \\ ( {\sum }_{k such that i ∈ {S}_{k , c + 1}} {w}_{i , k} {δ}_{k , c + 1} ) {Φ}^{′} ( {V}_{i , c} ) & si c \neq C\end{matrix}$$

where

φ′(x)=1−tan h²(x)
update the weights of the synapses arriving at the neuron i:

Δw_{j,i}^{new}=ρδ_{i,c}y_{j,c-1}+αΔw_{j,i}^{old}, ∀jεS_{i,c}
where ρ is the learning step and α the momentum

(Δw_{j,i}^{old}=0 during the first iteration)

w_{j,i}^{new}=w_{i,j}+Δw_{j,i}^{new} ∀jεS_{i,c}

Δw_{j,i}^{old}=Δw_{j,i}^{new} ∀jεS_{i,c}

w_{j,i}=w_{j,i}^{new} ∀jεS_{i,c}
compute the mean square error E (cf. equation 1)
   Up to E<ε or if a maximum number of iterations has been reached.

1. System for locating at least two points of interest in an object image, wherein the system applies an artificial neural network and presents a layered architecture comprising:
an input layer receiving said object image;
at least one intermediate layer, called a first intermediate layer, comprising a plurality of neurons enabling the generation of at least two saliency maps each associated with a predefined distinct point of interest of said object image; and
at least one output layer comprising said saliency maps,
said saliency maps comprising a plurality of neurons, each connected to all the neurons of said first intermediate layer, and
said points of interest being located in the object image, by the position of a unique overall maximum value on each of said saliency maps.

2. Locating system according to claim 1, wherein said object image is a face image.

3. Locating system according to claim 1, wherein the system also comprises at least one second intermediate convolution layer comprising a plurality of neurons.

4. Locating system according to claim 1, wherein the system also comprises at least one third sub-sampling intermediate layer comprising a plurality of neurons.

5. Locating system according to claim 1, wherein the system comprises, between said input layer and said first intermediate layer:
a second intermediate convolution layer comprising a plurality of neurons and enabling the detection of at least one elementary line type shape in said object image, said second intermediate layer delivering a convoluted object image;
a third intermediate sub-sampling layer comprising a plurality of neurons and enabling a reduction of the size of said convoluted object image, said third intermediate layer delivering a reduced convoluted object image;
a fourth intermediate convolution layer comprising a plurality of neurons and enabling the detection of its least one corner type complex shape in said reduced convoluted object image.

6. Learning method for a neural network of a system for locating at least two points of interest in an object image, the neural network comprising a layered architecture having at least one intermediate layer, called a first intermediate layer, comprising a plurality of neurons, each of said neurons having a least one input weighted by a synaptic weight, and a bias,
wherein the learning method comprises the steps of:
building a learning base comprising a plurality of object images annotated as a function of said points of interest to be located;
initializing at least one of said synaptic weights or said biases
for each of said annotated images of said learning base:
preparing said at least two desired saliency maps at the output from each of said at least two annotated, predefined points of interest on said image;
presenting said image at input of said system for locating and determining said at least two saliency maps delivered at the output;
minimizing a difference between said desired saliency maps delivered at the output on the set of said annotated images of said learning base so as to determine at least one of said synaptic weights or said optimal biases.

7. Learning method according to claim 6, wherein said minimizing is a minimizing of a mean square error between said desired saliency maps delivered at output and applies an iterative gradient backpropagation algorithm.

8. Method for locating at least two points of interest in an object image, comprising the steps of:
presenting said object image at input of a layered architecture implementing an artificial neural network;
successively activating at least one intermediate layer, called a first intermediate layer, comprising a plurality of neurons and enabling the generation of at least two saliency maps each associated with a predefined, distinct point of interest of said object image, and of at least one output layer comprising said saliency maps, said saliency maps comprising a plurality of neurons each connected to all the neurons of said first intermediate layer;
locating said points of interest in said object image by searching, in said saliency maps, for a position of a unique overall maximum on each of said maps.

9. Method of location according to claim 8, wherein the method comprises preliminary steps:
detection, in any image whatsoever, of a zone encompassing said object and constituting said object image;
resizing of said object image.

10. Computer program stored on a computer readable memory and comprising program code instructions for the execution of a learning method for a neural network, of a system for locating at least two points of interest in an object image, when said program is executed by a processor, the neural network comprising a layered architecture having at least one intermediate layer, called a first intermediate layer, comprising a plurality of neurons, each of said neurons having a least one input weighted by a synaptic weight, and a bias, wherein the learning method comprises the steps of:
building a learning base comprising a plurality of object images annotated as a function of said points of interest to be located;
initializing at least one of said synaptic weights or said biases
for each of said annotated images of said learning base:
preparing said at least two desired saliency maps at the output from each of said at least two annotated, predefined points of interest on said image;
presenting said image at input of said system for locating and determining said at least two saliency maps delivered at the output;
minimizing a difference between said desired saliency maps delivered at the output on the set of said annotated images of said learning base so as to determine at least one of said synaptic weights or said optimal biases.

11. Computer program stored on a computer readable memory and comprising program code instructions for execution of a method for locating at least two points of interest in an object image when said program is executed by a processor, the method comprising the steps of:
presenting said object image at input of a layered architecture implementing an artificial neural network;
successively activating at least one intermediate layer, called a first intermediate layer, comprising a plurality of neurons and enabling the generation of at least two saliency maps each associated with a predefined, distinct point of interest of said object image, and of at least one output layer comprising said saliency maps, said saliency maps comprising a plurality of neurons each connected to all the neurons of said first intermediate layer;
locating said points of interest in said object image by searching, in said saliency maps, for a position of a unique overall maximum on each of said maps.
